(19) United States
(12) Patent Application Publication
(10) Pub. No.: US 2020/0171490 A1
(43) Pub. Date: Jun. 4, 2020

(54) LIQUID HANDLING, IN PARTICULAR METERING

(71) Applicant: BIOSURFIT, S.A., Aveiro (PT)

(72) Inventors: Fábio Miguel Rolo PEREIRA, LISBOA (PT); Miguel João MARQUES BARREIROS, LISBOA (PT); David Pena De Sousa SANTOS, LISBOA (PT)

(73) Assignee: BIOSURFIT, S.A., Aveiro (PT)

(21) Appl. No.: 16/617,864

(22) PCT Filed: May 31, 2018
(86) PCT No.: PCT/EP2018/064369

§ 371 Date: Nov. 27, 2019

(30) Foreign Application Priority Data
May 31, 2017 (GB) 1708623.2
May 31, 2017 (PT) 110118 T

(51) Int. Cl. B01L 3/00

(52) U.S. Cl. CPC B01L 3/50273; B01L 3/502715; B01L 2400/0406; B01L 2300/06; B01L 2400/0409; B01L 2200/0605

(57) ABSTRACT

A microfluidic liquid handling device is configured for rotation about an axis of rotation to drive liquid flow within the device. The device can include an upstream liquid handling structure, a metering structure and an overflow region. The metering structure is configured to receive liquid from the upstream liquid handling structure. The overflow region is separated from the metering structure by a wall. The wall has a first surface portion on the side of the overflow region which has an extent in a direction perpendicular to the direction of action of the centrifugal force, in a substantially tangential or circumferential direction, relative to the axis of rotation. The first surface portion faces radially outwards. Advantageously, the structure of the wall facilitates accurate metering.

### TECHNICAL FIELD

The present disclosure relates to handling of liquids, for example in a microfluidic device such as a lab on a disk' device. In particular, although not exclusively, the present disclosure relates to a structure facilitating the metering of liquid.

### BACKGROUND

In many liquid handling applications it is desirable to allow liquid to overflow from an upstream liquid containing structure to a downstream liquid containing structure, for example to meter a volume of liquid in the upstream liquid containing structure, or to aliquot a volume of liquid into separate aliquots.

### SUMMARY

Aspects of the disclosure are set out in the independent claims. Further, optional features of embodiments are set out in the dependent claims.

In one aspect there is provided a microfluidic liquid handling device configured for rotation about an axis of rotation to drive liquid flow within the device. The device comprises an upstream liquid handling structure, a metering structure and an overflow region. The metering structure is configured to receive liquid from the upstream liquid handling structure. The overflow region is separated from the metering structure by a wall. The wall has a first surface portion on the side of the overflow region which has an extent in a direction perpendicular to the direction of action of the centrifugal force, in a substantially tangential or circumferential direction, relative to the axis of rotation. The first surface portion faces radially outwards.

Advantageously, the described structure “shadows” a region of the wall facing the overflow region from the centrifugal force, so that this region of the wall is not wetted by overflowing liquid, in effect breaking the liquid meniscus along the wall. This reduces the tendency for liquid to be drawn back into the metering structure due to surface tension forces along a continuously wetted surface between the metering chamber and overflow region. As a result, metering accuracy may be improved.

In some embodiments, the wall has a second surface portion on the side of the overflow region and having an extent in the direction perpendicular to the direction of action of the centrifugal force. The second surface portion is radially inward of the first surface portion and faces radially inward. In some embodiments, the first and second surface portions form a projection (or overhang or cantilever) projecting into the overflow region.

In some embodiments, the device comprises a chamber which comprises the metering structure and the overflow region and the wall which separates the overflow region from the metering structure is a wall of the chamber. For example, both the metering structure and the overflow region may be defined by a wall of the chamber and the wall of the chamber extends radially inwards from the metering structure to a crest and radially outwards from the crest to the overflow portion, thus separating the metering structure from the overflow portion.

In other embodiments, the device comprises a cavity. A cavity will be understood to be an empty space inside the device in which fluid can be contained or guided. The metering structure is disposed within the cavity. For example, the cavity may comprise one or more structures, such as walls, which define the metering structure within the cavity. These structures may form an open-topped chamber within the cavity, for example. In some embodiments, the metering structure is formed by two walls, one or both of which are each angled with respect to a respective radial direction to form a funnel shape. The overflow region is a region of the cavity. For example, the cavity may be defined by one or more cavity walls and the overflow region is a region between a wall of the cavity and a wall of the metering structure. In use, liquid fills the metering structure and then overflows into the overflow structure, which may be, for example, a radially-outermost aspect of the cavity.

In some cases, the wall may be considered as forming a structure which may be described as an overhang, cantilever or projection, extending into the overflow region (or an indentation inwards into the wall). Under the action of centrifugal force, liquid flows over this structure, leaving a portion of the wall radially outwards of (or within) the structure dry. In other cases, the slant of a portion or all of the wall surface facing the overflow region means that at least a portion is ‘in the shadow’ of the centrifugal force and hence is not wetted. In some embodiments, the metering structure has an outlet which is connected to an outlet conduit. The outlet conduit is configured to facilitate flow of liquid along the outlet conduit under the action of capillary forces. In particular, the outlet conduit may be configured to facilitate flow of a liquid suspension, a liquid emulsion, or an aqueous liquid, for example a blood sample or a component of a blood sample, along the outlet conduit under the action of capillary forces. The outlet conduit may have at least one dimension which is smaller than 100 μm. For example, the depth of the outlet conduit may be 30 to 100 μm and a width of the outlet conduit may be 50 to 300 μm. The exact dimensions of the outlet conduit may depend on the materials used to form the device and the outlet conduit in particular. In embodiments where the device has the shape of a disc, the depth of the outlet conduit may be defined perpendicular to the plane of the disc and the width of the outlet conduit may be defined parallel to the plane of the disc.

In some embodiments, the outlet conduit may comprise a capillary siphon. In other words, the outlet conduit may extend radially inwards to a crest and then radially outwards from the crest. The crest may be disposed radially inwards of a fill level of liquid in the metering structure or a radially-innermost aspect of the metering structure. The capillary siphon acts to hold liquid in the metering structure as the metering structure fills under the action of centrifugal force. When rotation of the device is stopped or slowed to a sufficient degree, capillary forces acting to draw the liquid into the outlet conduit are no longer balanced by the centrifugal force and liquid thus flows along the outlet conduit. Once liquid has passed the crest of the siphon, rotation may be resumed (or the rotational frequency of the device increased) to drive liquid further along the outlet conduit.

In some embodiments, the metering structure has an outlet connected to another structure, not necessarily configured to facilitate liquid flow by capillary. For example, the outlet of the metering structure may be connected to a structure such as that described in application GB1617083.9.

In a further aspect there is provided a liquid handling device configured for rotation about an axis of rotation to drive liquid flow within the device. The device comprises an upstream liquid handling structure, a metering structure configured to receive liquid from the upstream liquid handling structure and an overflow region. The overflow region is separated from the metering structure by a wall which comprises a patch of hydrophobic material.

This facilitates a break in a wetted surface of the wall between liquid in the metering structure and liquid in the overflow region and thus avoiding a continuous wetted surface on the wall separating the two liquid volumes. The wetted surface has at least two wetted regions separated by the break. As liquid overflows from the metering structure into the overflow region, the meniscus of the overflowing liquid along the wall is broken by the hydrophobic patch, leaving the hydrophobic patch substantially dry and preventing a continuous meniscus of liquid between the metering structure and overflow region. In some embodiments, the hydrophobic patch extends from the wall into the overflow region along one or more other confining surfaces of the overflow region.

In a further aspect there is provided method of handling liquid in a liquid handling device which comprises a metering structure and an overflow region separated from the metering structure by a wall. The method comprises rotating the device to transfer liquid into the metering structure and subsequently from the metering structure into the overflow region and causing a break in a wetted surface of the wall between the metering structure and overflow region. As a consequence, the wetted surface has at least two wetted regions separated by the break. This can be achieved in any suitable way, for example by using the above-described structures, for example.

In some embodiments, the method comprises changing, for example decreasing, the rotational frequency of the device to transfer liquid in the metering structure out of the metering structure, for example under the action of capillary forces. For example, as described above, the metering structure may comprise an outlet which is connected to an outlet conduit which comprises a capillary siphon or other flow control device, such as a surface tension valve or a structure as described in GB1617083.9, herewith incorporated by reference. In the case of a capillary siphon, liquid may be prevented from traversing the crest of the siphon under the action of centrifugal force. When the device is slowed (or stopped), capillary forces acting to draw liquid into the outlet conduit are no longer balanced by centrifugal forces and liquid flows along the outlet conduit and over the crest. The rotational frequency of the device may then be increased (or rotation resumed) once liquid has traversed the crest to drive liquid flow along the outlet conduit.

### BRIEF DESCRIPTION OF THE DRAWINGS

Specific embodiments are now described by way of example and for the purpose of illustration, with reference to the accompanying drawings in which:

FIG. 1a illustrates schematically a liquid handling device;

FIGS. 1b and 1c illustrate schematically liquid flow within the device in FIG. 1a;

FIG. 2 illustrates schematically an expanded view of a portion of the liquid handling device shown in FIGS. 1a, 1b and 1c;

FIG. 3a illustrates schematically a further liquid handling device;

FIGS. 3b and 3c illustrate schematically liquid flow within the device in FIG. 3a;

FIG. 4 illustrates schematically yet a further liquid handling device;

FIGS. 5a to 5e illustrate schematically yet further liquid handling devices;

FIG. 6 illustrates schematically yet a further liquid handling device; and

FIG. 7 illustrates schematically yet a further liquid handling device.

### DETAILED DESCRIPTION

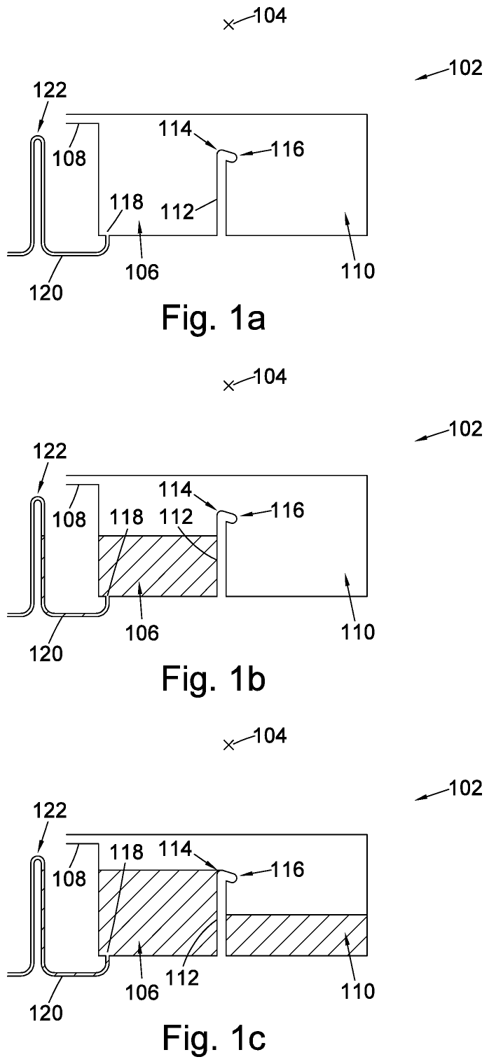

With reference to FIG. 1a, a liquid handling device 102 is configured for rotation about an axis of rotation 104 to drive liquid flow in the device as described above. For example, as mentioned above, the device 102 could be a disk, for example a microfluidic disk. The device 102 may comprise a coupling feature configured to engage with a drive mechanism for driving rotation of the device 102.

The device 102 comprises a chamber 106 with an inlet 108. The chamber 106 may be a sedimentation chamber in which a liquid sample (e.g. a blood sample) is separated into its constituent parts of differing densities under centrifugal force. It will be appreciated that this chamber 106 is not so limited, however. For example it could be a metering chamber that is not used for sedimentation. The inlet 108 of the chamber 106 is connected to an upstream liquid handling structure (not shown).

The chamber 106 is connected to an overflow chamber 110. The chamber 106 is separated from the overflow chamber 110 by a wall 112 of the chamber 106. The wall 112 extends from a radially outwards side of the chamber 106, radially inwards (i.e. towards the axis of rotation 104) to a crest 114 and radially outwards (i.e. away from the axis of rotation 104) from the crest 114 to the overflow chamber 110. The wall 112 comprises a projection 116 which projects into the overflow chamber 110. In particular, the wall 112 extends in a first circumferential direction to a first point and then in a second circumferential direction opposed to the first direction to form the projection 116. The projection 116 may also be referred to as an overhang or cantilever. The size and dimensions of the projection will depend on several factors such as the rate of rotation of the device, the volume of liquid involved and the geometry of the overflow chamber 110 and of the chamber 106. In general, the dimensions of the projection may be of the order of half a millimetre to a few millimetres.

The chamber 106 further comprises an outlet 118. The outlet 118 is connected to an outlet conduit 120, which is dimensioned so as to facilitate flow of liquid, in particular an aqueous liquid, along the conduit 120 under the action of capillary forces. The outlet conduit 120 extends radially inwards to a crest 122, the crest 122 being disposed radially inwards of the crest 114, thus forming a capillary siphon. As the chamber 106 fills with liquid, liquid is prevented from traversing the crest 122 and is instead held upstream of the crest under the action of centrifugal force.

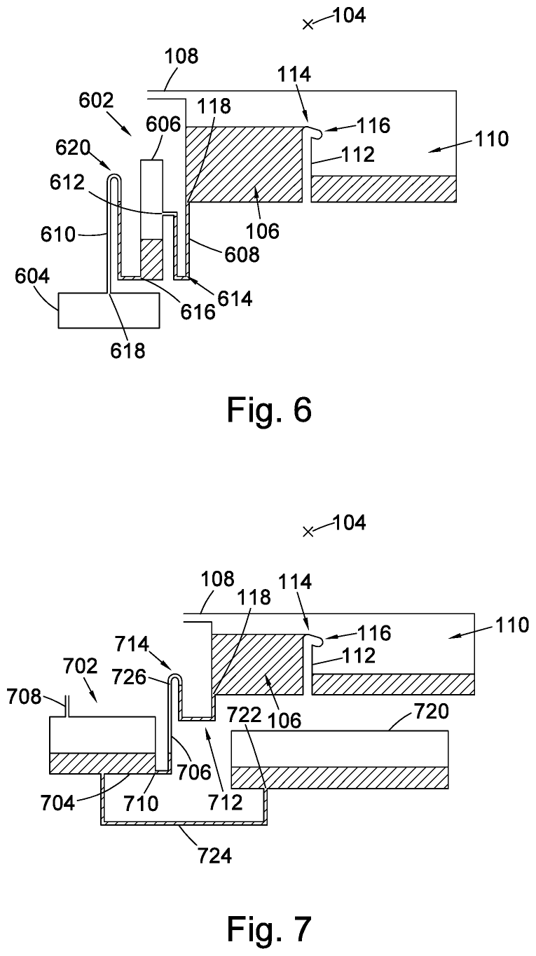

It will be appreciated that means other than a capillary siphon may be used to control the flow of liquid along the conduit 120 (for example, as discussed with reference to FIGS. 6 and 7). Any liquid flow control feature which halts liquid flow along the conduit 120 as the chamber 106 is filled with liquid under the action of centrifugal force but is then overcome when the rotation speed of the device is changed, for example slowed or stopped, may be used. For example, a capillary valve or a valve such as that described in application GB1617083.9 may be used.

With reference to FIGS. 1b and 1c, liquid flow within the device 102 is now described. As a first step, the device 102 is rotated about the axis of rotation 104 to transfer liquid from the upstream liquid handling structure (not shown) into the chamber 106 via the inlet 108 under the action of centrifugal force. The chamber 106 begins to fill with liquid. Liquid also enters the outlet conduit 120 but is held upstream of the crest 122 under the action of centrifugal force.

As liquid enters the chamber 106, a fill level of liquid rises (i.e. moves radially inwards). Eventually, the fill level reaches the radial position of the crest 114 and liquid overflows into the overflow chamber 110. This is shown in FIG. 1c.

Rotation of the device 102 is then stopped (or the rotational frequency of the device is at least reduced) and, any excess liquid having overflowed into overflow chamber 110, a well-defined volume of liquid is left in the chamber 106. Capillary forces acting to draw liquid into the conduit 120 which were previously balanced by the centrifugal force provided by rotation of the device now cause liquid to flow along conduit 120, out of the chamber 106. Liquid traverses the crest 122 and moves radially outwards again. Once liquid has traversed the crest 122, the device 102 is rotated again to drive liquid flow along conduit 120 and extract the well-defined volume of liquid from the chamber 106.

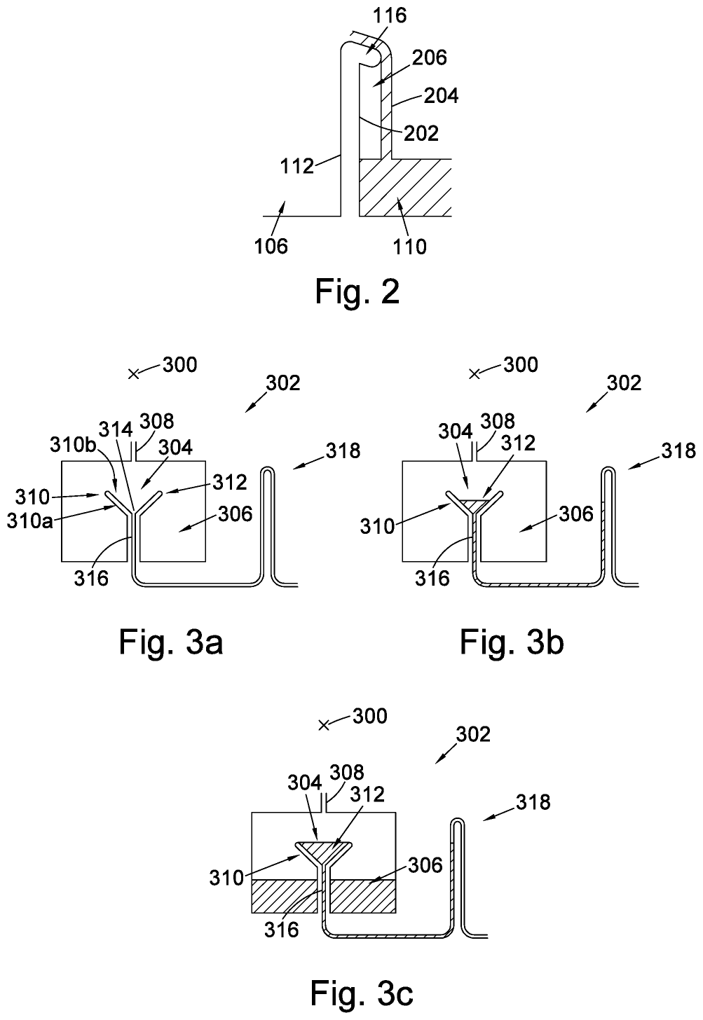

Advantageously, the projection 116 on the wall 112 causes a break in a wetted surface of the wall when liquid overflows from the chamber 106 into the overflow chamber 110. As a result, liquid in the overflow chamber 110 is held in the overflow chamber 110 and is prevented from flowing out of the overflow chamber 110 when liquid in the chamber 106 flows out of the chamber via the outlet 118. This effect is described in more detail with reference to FIG. 2.

FIG. 2 illustrates an enlarged view of the wall 112 and the projection 116. When liquid fills the chamber 106 and overflows into the overflow chamber 110, the projection 116 prevents a portion of the wall 112 (labelled as 202 in FIG. 2) which faces the overflow chamber 110 and is radially outwards of the projection 116 from becoming wet. Instead, liquid flows over the projection 116 and follows path 204, which is displaced from the wall 112 and in particular portion 202. Region 206 of the chamber 110 thus stays dry. This means that once liquid flow into chamber 106 has ceased, and liquid has overflowed into overflow chamber 110, there is no continuous meniscus along the wall 112 connecting liquid in the chamber 106 with liquid in the overflow chamber 110, as would be the case if projection 116 was not present and the wall 112 connecting the chamber 106 to the overflow chamber 110 was wetted. As a result, when liquid flows out of the chamber 106 by capillary action, liquid in the overflow chamber 110 is less likely to be drawn back into the chamber 106. Accordingly, the well-defined volume of liquid (in the chamber 106) is kept separated from the remainder of the liquid, in the overflow chamber 110 and this well-defined liquid can then be caused to flow on downstream, out of the chamber 106. It will be appreciated that the overflow chamber 110 is preferably sufficiently large such that it does not fill with liquid up to the level of the overhang to ensure that at least a portion of the wall stays dry.

It may also be advantageous to configure the overflow chamber 110 such that the overflow chamber 110 extends radially outwards of the chamber 106. This structure means that, when liquid collects in the radially-outermost aspect of the overflow chamber 110, there is a longer distance between liquid in the overflow chamber 110 and liquid in the chamber 106. This may aid in preventing the formation of a continuous meniscus between liquid in the chamber 106 and in the overflow chamber 110.

The Coriolis force can be taken into account in determining the size and shape of the projection 116. In particular, deflection of the liquid towards the portion 202 of the wall 112 (see FIG. 2) as a result of the Coriolis force as the device 102 is rotated must be taken into account in ensuring that at least part of the wall 112 (i.e. portion 202) stays dry when liquid overflows from the chamber 106 into the overflow chamber 110. This can be achieved by making the projection 116 large enough and in particular, by making the tangential extent of the projection 116 (with respect to the axis of rotation 104) large enough.

With reference to FIG. 3a, a further embodiment of the device employing a shaped wall to break a wetted surface of the wall is shown. In these embodiments, a device 302 comprises a metering structure 304 disposed within a cavity 306. The device 302 is configured for rotation about an axis of rotation 300 to drive liquid flow in the device as described above. The metering structure 304 and the cavity 306 serve the same purposes as the chamber 106 and the overflow chamber 110 in the device 102 of the embodiment of FIGS. 1a to 1c, as will now be described.

The cavity 306 comprises an inlet 308 which is in fluidic communication with an upstream liquid handling structure (not shown). The metering structure 304 is disposed within the cavity and is defined by a first wall 310 and a second wall 312, each of which are angled with respect to a respective radial direction, thus forming a ‘V’ shaped metering structure. The first wall 310 has a first surface 310a and a second surface 310b which is radially spaced from the first surface 310a. Both the first and second surfaces 310a and 310b have an extent in a direction which is perpendicular to the direction of action of the centrifugal force.

The metering structure 304 has an outlet 314 which is connected to an outlet conduit 316. The outlet conduit extends radially inwards to a crest 318, which is disposed radially inwards of a radially-innermost aspect of the metering structure 304.

As mentioned above, the metering structure 304 is disposed within a cavity 306. The metering structure is disposed directly, or substantially directly, radially outwards of the inlet 308 of the cavity 306 such that when liquid enters the cavity 306 it is transferred into metering structure 304. The outlet conduit 316 passes through an opening in a wall of the cavity 306.

With reference to FIG. 3b, in use, liquid is transferred into the cavity 306 via the inlet 308 from the upstream liquid handling structure (not shown) under the action of centrifugal force by rotating the device 302 about the axis of rotation 300. Liquid enters the metering structure 304 and the metering structure 304 fills with liquid. As the metering structure 304 fills, a fill level of liquid in the metering structure 304 rises. As shown in FIG. 3c, eventually, the fill level reaches the radially-innermost aspect of the walls 310 and 312. Liquid then overflows, out of the metering structure, and collects in the cavity 306.

Once liquid flow into the cavity 306 ceases and any excess liquid has overflowed out of the metering structure and into the cavity 306, a well-defined volume of liquid is held in the metering structure 304. This volume can then be extracted from the metering structure 304 via the conduit 18 in the same way as described above with reference to FIGS. 1a, 1b and 1c. In short, rotation of the device 302 is slowed or stopped. Capillary forces which were previously balanced by the centrifugal force act to draw liquid in the conduit 316 over the crest 318. Rotation is then resumed (or the rotational frequency of the device increased) to cause liquid to flow along the conduit 316.

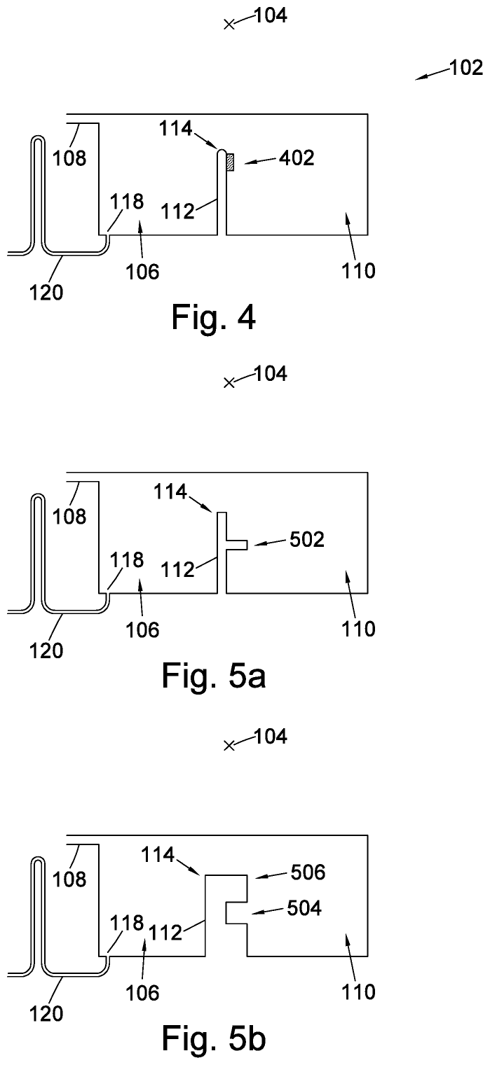

Aside from a structure having a first surface portion on the side of the overflow region with an extent in a direction perpendicular to the direction of action of the centrifugal force, in a substantially tangential or circumferential direction, relative to the axis of rotation, and which faces radially outwards an extent in a direction perpendicular to the direction in which the centrifugal force acts, another way of breaking a wetted surface of the wall that may be employed is the use of a patch of a hydrophobic material, as will now be described with reference to FIG. 4.

The structure illustrated in FIG. 4 is substantially the same as that for FIG. 1a with the exception that the projection 116 is replaced with a patch 402 comprising hydrophobic material . In some embodiments, the patch 402 may extend away from the wall along adjacent surfaces of the overflow chamber 110. This hydrophobic patch 402 has a similar effect as the projection 116 in the embodiment shown in FIG. 1a and the angled walls 310, 312 shown in FIG. 3a.

In use, when liquid overflows into the overflow chamber 110 from the chamber 106, liquid flows over the hydrophobic patch 402, which spans substantially all of the wall (in an axial direction) and, in some embodiments, a portion of the adjacent liquid confining surfaces. As flow is reduced, the hydrophobic patch breaks the meniscus along the wall 112 as water is repelled from it. As a result, when liquid flows out of the chamber 106 by capillary action, liquid in the overflow chamber 110 is less likely to be drawn over the wall 112 by surface tension effects but instead remains in the overflow chamber 110.

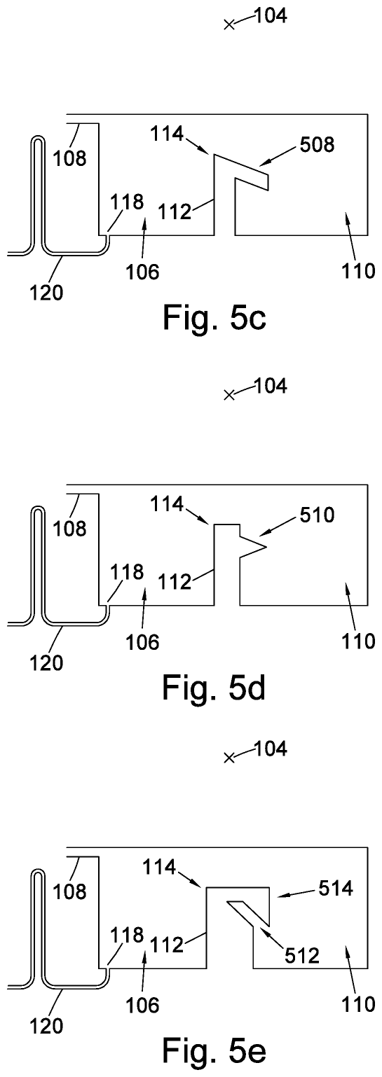

With reference to FIGS. 5a to 5e, further embodiments of the device employing a shaped wall to break a wetted surface of the wall are described. The structure illustrated in FIG. 5a is substantially the same as that for FIG. 1a with the exception that a projection 502 is radially outwards of the crest 114. The projection 502, in some embodiments, extends in a substantially tangential direction relative to the axis of rotation. In other embodiments, the projection 502 comprises a component in a radially outwards direction.

The structure illustrated in FIG. 5b is substantially the same as that for FIG. 1a with the exception that the wall 112 comprises a recess 504 on the side facing the overflow chamber 110 such that a projection 506 is formed by the radially inner part of the wall 112.

The structure illustrated in FIG. 5c is substantially the same as that for FIG. 1a with the exception that a projection 508 extends in a substantially tangential direction relative to the axis of rotation with a component in a radially outwards direction (i.e. away from the axis of rotation 104) further into the overflow chamber 110.

The structure illustrated in FIG. 5d is substantially the same as that for FIG. 1a with the exception that a projection 510 is radially outwards of the crest 114, and that the projection 510 has a triangular shape.

The structure illustrated in FIG. 5e is substantially the same as that for FIG. 1a with the exception that the wall 112 comprises a recess 512 on the side facing the overflow chamber 110 such that a projection 514 is formed by the radially inner part of the wall 112. Further the radially inner portion of the wall 112 extends further into the overflow chamber 110 than the radially outer portion of the wall 112 such that the projection 514 overhangs the lower radially outer portion of the wall 112.

In use, as described with respect to the embodiment of FIG. 1a, the projections 502, 506, 508, 510 and 514 of FIGS. 5a to 5e respectively on the wall 112 causes a break in the wetted surface of the wall when liquid overflows from the chamber 106 into the overflow chamber 110. As a result, when liquid ceases to flow into the overflow chamber and then, for example, flows out of the chamber 106 by capillary action or otherwise, liquid in the overflow chamber 110 is less likely to be drawn back over the wall 112 by surface tension effects but instead remains in the overflow chamber 110. This break in the wetted surface of the wall thus can reduce the risk of re-filling the chamber 106 with liquid from the overflow chamber 110, which could be critical to ensure there is no additional liquid being transferred from chamber 106 to the downstream structure at a later stage. Consequently, the accuracy of metering, in particular of small volumes of liquid, may be improved.

It will be appreciated that, in some embodiments, the outlet 118 of the metering structure is connected to another structure, and not necessarily configured to facilitate liquid flow by capillary in which the crest 122 of the siphon is radially innermost relative to the crest 114 of the wall 112. For example, the outlet 118 may be connect to a flow control device as described in application GB1617083.9 (and discussed with reference to FIG. 6), or to a liquid handling structure as described in application GB1617079.7 (and discussed with reference to FIG. 7).

With reference to FIG. 6, the outlet 118 of the metering structure is connected to a flow control device 602 for controlling liquid flow between the chamber 106 and a downstream chamber 604. The flow control device 602 comprises an unvented chamber 606 connected to the chamber 106 by an upstream conduit 608 and to the downstream chamber 604 by a downstream conduit 610. The upstream conduit 608 extends from the outlet 118 of the chamber 106 to an inlet port 612, of the unvented chamber 606, and forms a bend 614 radially outward of the inlet port 612. The downstream conduit 610 extends from an outlet port 616 of the unvented chamber 606 to an inlet port 618 of the downstream chamber 604 and forms a bend 620 radially inward of the outlet port 616. The outlet 118 is radially inward of the inlet port 612, the inlet port 612 is radially inward of the outlet port 616, which is radially inward of the inlet port 618.

When the device is rotated about the axis of rotation 104, liquid flows into the unvented chamber 606, air is trapped radially inward of the liquid level in the unvented chamber 606 as soon as the outlet port 616 of the unvented chamber 606 is filled with liquid and as liquid continues to flow into the unvented chamber 606, the gas pressure in the unvented chamber 606 rises with the liquid level in the unvented chamber 606 until the gas pressure is balanced by the centrifugal pressure at the inlet port 612 of the unvented chamber 606 (with the liquid column in the downstream conduit rising accordingly to balance the pressure at the outlet port). When rotation of the device is then slowed, the centrifugal pressure is decreased and liquid is driven through the inlet and outlet ports of the unvented chamber 606 by the gas pressure in the chamber. If sufficient gas pressure has been built up, this will then push the liquid column in the downstream conduit 610 past the bend 620 and radially out of the liquid level in the unvented chamber 606, at which point any centrifugal force will cause emptying of the unvented chamber through the outlet port 616 as a result of a siphon effect, drawing liquid through the inlet port 612 of the unvented chamber 606 and hence from the chamber 106. By configuring the upstream conduit 608 connecting the chamber 106 and the unvented chamber 606 with a bend 614 radially outward of the inlet port 612 of the unvented chamber 606, the liquid column in the upstream conduit 608 is increased by the displacement of liquid with gas as the device is slowed, thereby preventing gas escaping upstream.

With reference to FIG. 7, the outlet 118 of the metering structure is connected to a liquid handling structure 702 for mixing two or more liquids. The liquid handling structure 702 comprises a downstream chamber 704 comprising an inlet 708 for receiving liquid from an upstream liquid handling structure (not shown) and a first port 710. The first port 710 is disposed on a radially outermost aspect of the downstream chamber 704. The downstream chamber 704 is vented. A first conduit 706 extends from the outlet 118 to the first port 710. The first conduit 706 extends radially outwards from the outlet 118 to a first bend 712 and then radially inwards from the first bend 712 to a crest 714. The first conduit 706 extends radially outwards from the crest to the first port 710.

The liquid handling structure 702 comprises an unvented chamber 720 which has a second port 722. A second conduit 724 connects the downstream chamber 704 to the second port 722. The second port 722 is disposed in a radially-outermost aspect of the unvented chamber 720. In particular, the second conduit 724 is connected to the downstream chamber 704 at a point which is radially outwards of the first port 710. When liquid is present in the portion of the first conduit 706 between the point of connection of the first and second conduits and the first port 710, this additional liquid provides additional liquid head which serves to increase the rotational frequency at which the device must be rotated in order to vent gas 726 trapped in the first conduit 706 into the downstream chamber 704. It may thus aid in preventing the gas 726 trapped in the first conduit 706 from being vented as soon as rotation is begun.

Advantageously, by trapping gas in the first conduit 706, the two liquid volumes in the downstream chamber 704 and the chamber 106 respectively can be kept apart until the rotational frequency is increased to a sufficiently high level, at which point the trapped gas is vented through the downstream chamber 704 and liquid from the chamber 106 is transferred into the downstream chamber 704, where it combines with liquid in the downstream chamber 704. This can be achieved without having to stop rotation of the device (as must be done for a capillary siphon, for example).

The above description of embodiments is made by way of example only and various modifications, alterations and juxtapositions of the described features will occur to the person skilled in the art. It will therefore be apparent that the above description is made for the purpose of illustration of embodiments of the invention and not limitation of the invention, which is defined in the appended claims.

1. A microfluidic liquid handling device configured for rotation about an axis of rotation to drive flow of a liquid within the device, the device comprising:
an upstream liquid handling structure;
a metering structure configured to receive liquid from the upstream liquid handling structure; and
an overflow region;
wherein the overflow region is separated from the metering structure by a wall which comprises at least:
a first surface portion on the side of the overflow region with an extent in a direction tangential relative to the axis of rotation, wherein the first surface portion faces radially outwards.

2. A device as claimed in claim 1, wherein the wall comprises a second surface portion on the side of the overflow region which has an extent in a direction perpendicular to the direction of action of the centrifugal force and which is radially inwards of the first surface portion and faces radially inward.

3. A device as claimed in claim 2, wherein the first and second surface portions form a projection projecting into the overflow region.

4. A device as claimed in claim 1, wherein the device comprises a chamber which comprises the metering structure and the overflow portion, wherein the wall separating the metering structure from the overflow region is a wall of the chamber.

5. A device as claimed in claim 1, wherein the device comprises a cavity and the metering structure is disposed within the cavity, the overflow region being a region of the cavity.

6. A device as claimed in claim 1, wherein the metering structure has an outlet which is connected to an outlet conduit and wherein the outlet conduit is configured to facilitate flow of liquid along the outlet conduit under the action of capillary forces.

7. A device as claimed in claim 1, wherein the outlet conduit comprises a siphon, optionally a capillary siphon.

8. A device as claimed in claim 1, wherein the liquid is an aqueous liquid.

9. A device as claimed in claim 1, wherein the liquid is a liquid suspension, a liquid emulsion or a blood sample.

10. A microfluidic liquid handling device configured for rotation about an axis of rotation to drive liquid flow within the device, the device comprising:
an upstream liquid handling structure;
a metering structure configured to receive liquid from the upstream liquid handling structure; and
an overflow region separated from the metering structure by a wall which comprises a patch of hydrophobic material.

11. A method of handling liquid in a liquid handling device comprising a metering structure and an overflow region separated from the metering structure by a wall, the method comprising:
rotating the device to transfer liquid into the metering structure and subsequently from the metering structure into the overflow region; and
causing a break in a wetted surface of the wall between the metering structure and overflow region.

12. A method as claimed in claim 11 further comprising:
changing the rotational frequency of the device to transfer liquid in the metering structure out of the metering structure.

13. A method as claimed in claim 11 further comprising:
decreasing the rotational frequency of the device to transfer liquid in the metering structure out of the metering structure under the action of capillary forces.
